(19) United States
(12) Patent Application Publication
(10) Pub. No.: US 2012/0069232 A1
(43) Pub. Date: Mar. 22, 2012

(54) CURVILINEAR CAMERA LENS AS MONITOR COVER PLATE

(75) Inventors: Clarence Chui, San Jose, CA (US); Matthew S. Grob, La Jolla, CA (US)

(73) Assignee: QUALCOMM MEMS TECHNOLOGIES, INC., San Diego, CA (US)

(21) Appl. No.: 13/217,117

(22) Filed: Aug. 24, 2011

Related U.S. Application Data
(60) Provisional application No. 61/383,663, filed on Sep. 16, 2010.

(51) Int. Cl. H04N 5/225

(52) U.S. Cl. 348/333.01; 348/340; 348/E05.024

(57) ABSTRACT

Disclosed are various implementations of a camera lens that can be positioned between a display device and a user viewing the display device. The camera lens can be transparent to allow such viewing by the user, and also be configured to capture light rays from the user and turn such rays to an imaging sensor to form an image of the user. Such turning of light rays can be achieved by curved features formed on the camera lens. In some implementations, the camera lens is a substantially flat layer having such curved features. Various examples of the curved features are disclosed. Also disclosed are systems and methods for enhancing the image of the user in situations where a portion of a display being viewed is captured by the camera lens and combines with the image of the user.

### CROSS-REFERENCE TO RELATED APPLICATIONS

This disclosure claims priority to U.S. Provisional Patent Application No. 61/383,663, filed Sep. 16, 2010, entitled “CURVILINEAR CAMERA LENS AS MONITOR COVER PLATE,” and assigned to the assignee hereof. The disclosure of the prior application is considered part of, and is incorporated by reference in, this disclosure.

### TECHNICAL FIELD

This disclosure generally relates to the field of user interface devices, and more particularly, to systems and methods for utilizing a camera lens with a display device such as an interferometric modulator based device.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Certain user interface devices for various electronic devices can include a display component and an input component. The display component can be based on one of a number of optical systems such as liquid crystal display (LCD) and interferometric modulator (IMOD). The input component can include a camera that is typically positioned near or outside the periphery of the display.

### SUMMARY

The systems, methods and devices of the disclosure each have several innovative aspects, no single one of which is solely responsible for the desirable attributes disclosed herein.

One innovative aspect of the subject matter described in this disclosure can be implemented in an imaging device having an optically transparent lens layer forming a light guide and having a plurality of curved features. At least some of the curved features are configured to turn light rays incident thereon toward an edge portion of the lens layer. The imaging device further includes an imaging sensor positioned relative to the edge portion of the lens layer and configured to receive at least some of the turned light rays so as to allow formation of an image based on the incident rays.

In some implementations, the curved features can include a plurality of circular arc shaped features. In some implementations, the curved features such as facets or grooves can be formed on one of two surfaces of the lens layer. In some implementations, the curved features can include a first set of curved features distributed on the lens layer according to a first pattern. In some implementations, diffractive or holographic features that form a diffractive optical element (e.g., lens) or hologram (e.g., holographic lens) that collect and turn the light and form an image on the imaging sensor can be used.

Another innovative aspect of the subject matter described in this disclosure can be implemented in a user interface apparatus that includes an active display device configured to receive an input signal and generate a visual display viewable from a viewing side of the active display device. The apparatus further includes a camera including a lens layer and an imaging sensor disposed at or near an edge of the lens layer, with the lens layer having features configured to turn incident light rays to the imaging sensor. The imaging sensor is configured to receive the turned light rays and generate signals that allow formation of an image corresponding to the incident light rays. The lens layer is disposed relative to the active display device such that the camera is capable of forming an image of an object positioned on the viewing side of the active display device.

In some implementations, the apparatus can further include a processor that can be configured to communicate with the active display device, with the processor being configured to process display data for generating the visual display, and a memory device that can be configured to communicate with the processor.

In some implementations, the lens layer can be dimensioned similar to the lateral dimensions of the active display device so as allow the lens layer to function as a cover plate for the active display device. In some implementations, the lens layer can include a substantially flat lens layer.

Yet another innovative aspect of the subject matter described in this disclosure can be implemented in a method for operating a user interface. The method includes providing an input signal to an active display device so as to generate a visual display. The method further includes obtaining an image signal representative of an object such as a user positioned on a viewing side of the active display device. The image of the object is formed by an optical element positioned between the object and the active display device. The optical element is optically transparent so as to allow the visual display to be viewed through the optical element such that the image signal includes at least some display image representative of the visual display. The method further includes adjusting the image signal based on the input signal to remove at least a portion of the image signal so as to enhance the image of the object in the image signal.

In some implementations, the adjusting of the image signal can include filtering the at least some display image from the image signal. In some implementations, the display image can correspond to an image in a buffer at the time when the image signal is obtained.

Yet another innovative aspect of the subject matter described in this disclosure can be implemented in an apparatus having means for forming an image of an object with light guided therein, the image being formed at or near an edge portion of the image forming means. The apparatus further includes means for sensing the image so as to generate an image signal.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows a user interface device including a display device and an imaging device.

FIGS. 10A and 10B show an imaging device including a lens layer with curvilinear features configured to turn incident light rays from an object, and a detector configured to detect such turned light rays so as to allow formation of an image of the object.

FIG. 11 shows an example of an incident light ray being turned by a curvilinear feature of the lens layer.

FIGS. 12A and 12B show examples of image formation based on detection of turned light rays.

FIGS. 13A and 13B show examples of light turning features that can be formed on either or both sides of the lens layer.

FIG. 14 shows that in some implementations, light turning feature parameters such as density and type can be adjusted to accommodate various design needs.

FIGS. 15A and 15B show an imaging device including more than one lens layers so as to provide features such as improved spatial resolution.

FIGS. 16A and 16B show side sectional views, respectively, of the example implementations of FIGS. 15A and 15B.

FIGS. 17A and 17B shows that in some implementations, more than one set of light turning features and detectors can be provided for a given lens layer.

FIG. 18 shows that in some implementations, light turning features can be configured to receive and turn rays incident at different angles.

FIG. 19 shows an example configuration of the interface device of FIG. 9, where an image of a user viewing an active display device can be formed by a lens layer and a detector, and where such an image can be adjusted to account for artifacts resulting from known frames being provided to the active display device.

FIG. 20 shows a process that can be implemented to perform the image adjustment depicted in FIG. 19.

FIGS. 21A and 21B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

In some implementations as described herein, a display device having one or more features associated with interferometric modulators can be utilized in combination with a camera having a substantially flat lens layer coupled to an imaging sensor. In some implementations, such a camera can be utilized with other types of display devices.

The lens layer can include turning features that are configured to capture light rays from, for example, a user looking at the display device and turn such rays to the imaging sensor to form an image of, e.g., the user. The lens layer can be substantially transparent such that it can be positioned between the user and the display device. In some implementations, the location of objects or features on one or more objects in front of or forward the lens layer 102 can be can be mapped to a corresponding “output” location on one of the surfaces of the light guide (such as the edge where the detector 140 is located) and on the detector 140 itself. An example application includes a lens layer where images corresponding to a number of objects at different directions can be combined so as to yield a wide-angle or panoramic-view image. In another example, one or more objects at one or more locations relative to a lens layer can be imaged separately by one or more sets of turning features and their corresponding imaging sensors. In some implementations, for example, two or more sets of turning features can be utilized to obtain corresponding two or more different perspective images (e.g., two or more angular perspectives obtained by configuring the turning angles slightly differently); and such images can be used to reconstruct a three-dimensional view. In some implementations, the imaging device includes more than one lens layers so as to provide features such as improved spatial resolution. Various non-limiting examples of such a camera are described herein.

Particular implementations of the subject matter described in this disclosure can be implemented to realize one or more of the following potential advantages. A lens layer can be transparent and provide a cover for a display device, and can include turning features that can be configured to capture light rays from, for example, a user looking at the display device and turn such rays to an imaging sensor to form an image of the user. Such positioning of the lens allows the user to view the display device and be imaged while looking at the display device. As discussed above, such a feature can be utilized in a number of situations, including video-conferencing applications, web-camera based applications, and gaming applications. Typically, a user of such a system finds it more natural to look at the monitor and not the camera. Accordingly, a person viewing the user will see the user not looking at the camera and thereby not providing an eye-contact atmosphere that the video conference is trying to facilitate. In some implementations, a lens layer can be configured to be utilized as a transparent overlay over another object such as a display item (e.g., a poster, artwork, signs, etc.). Used in such a manner, the lens layer can be utilized to form images of one or more objects viewing the display item and/or the display item itself.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

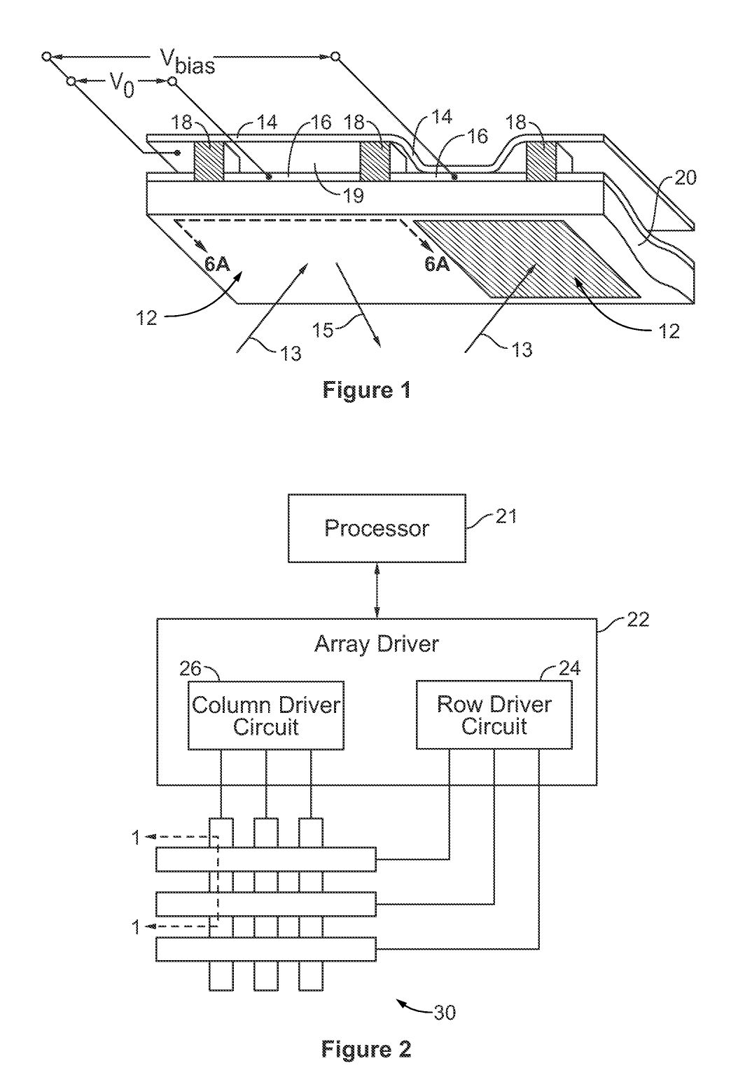

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

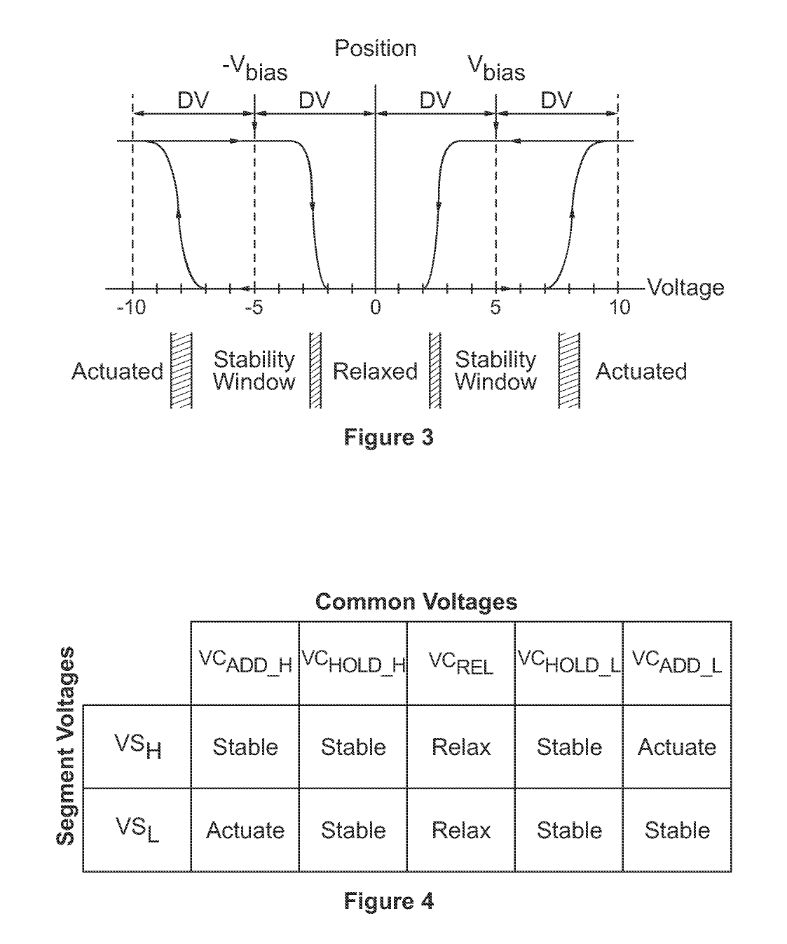

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

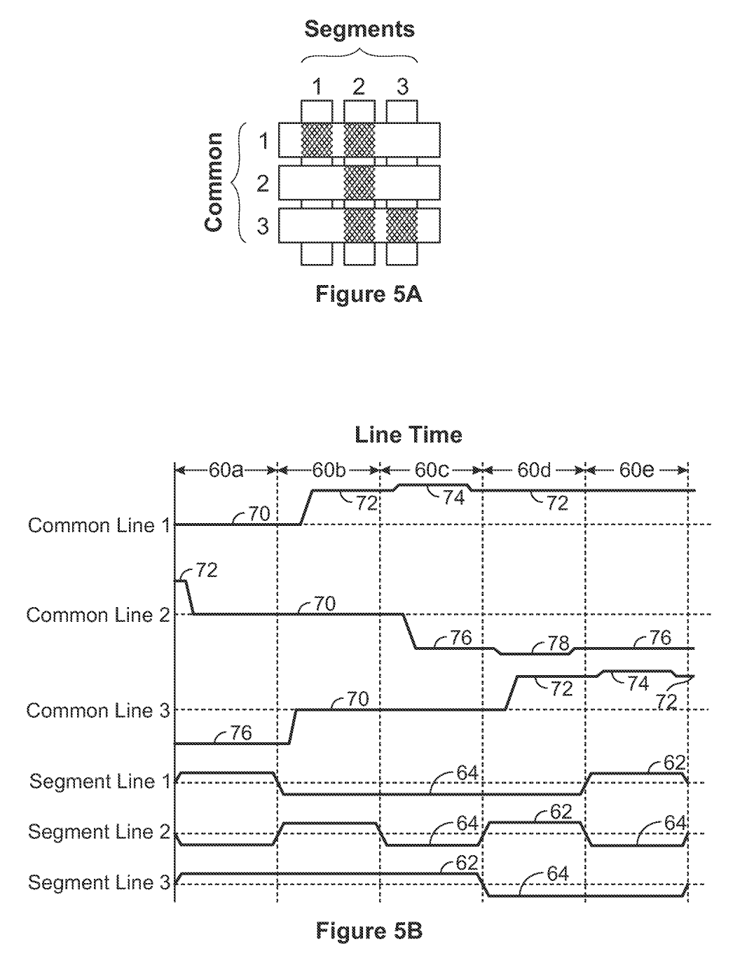

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

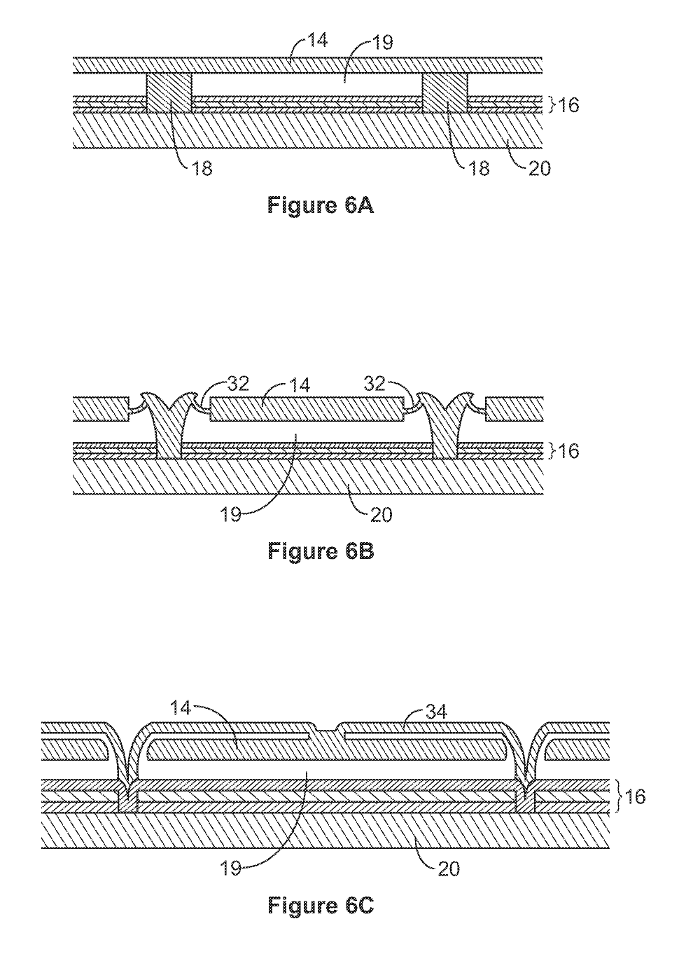

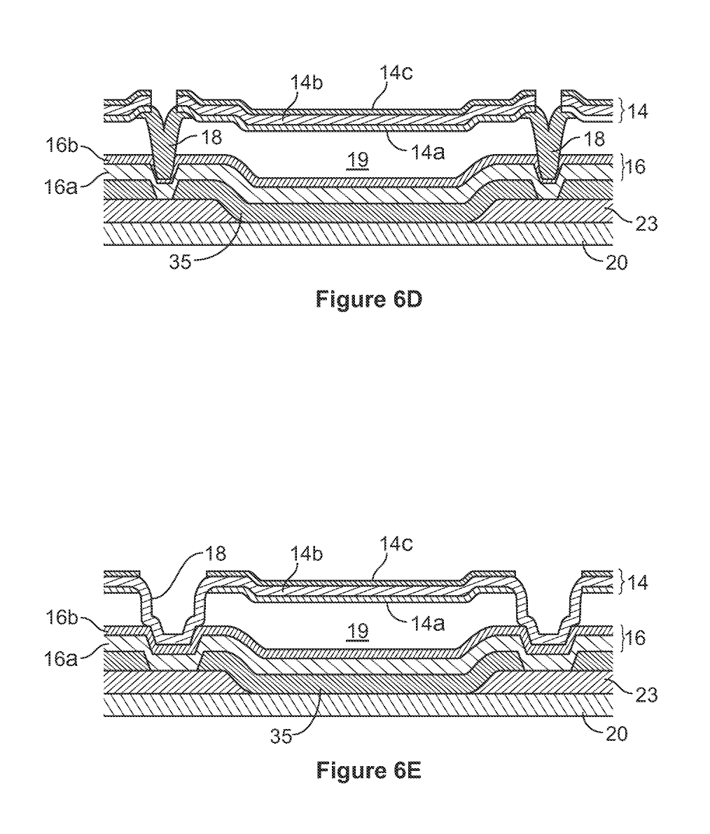

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

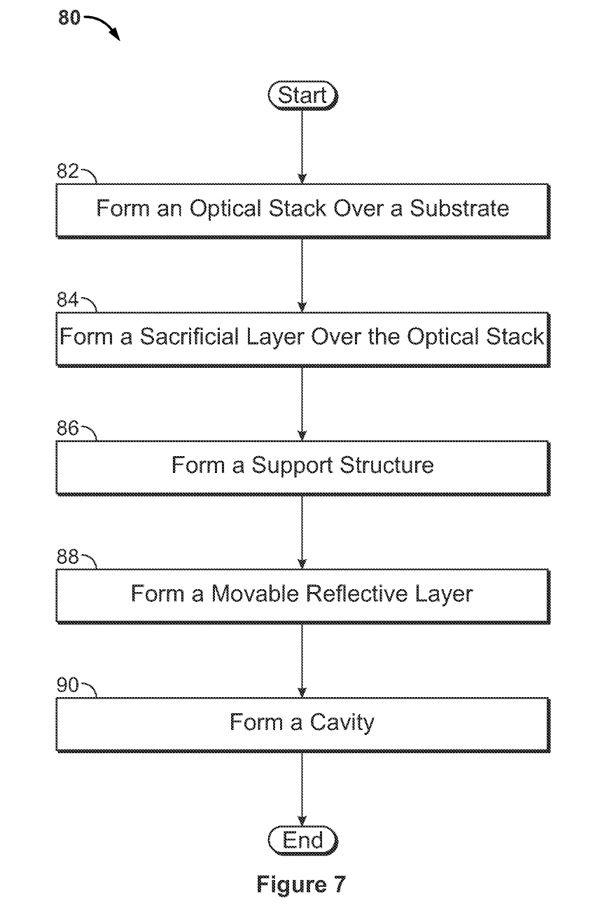

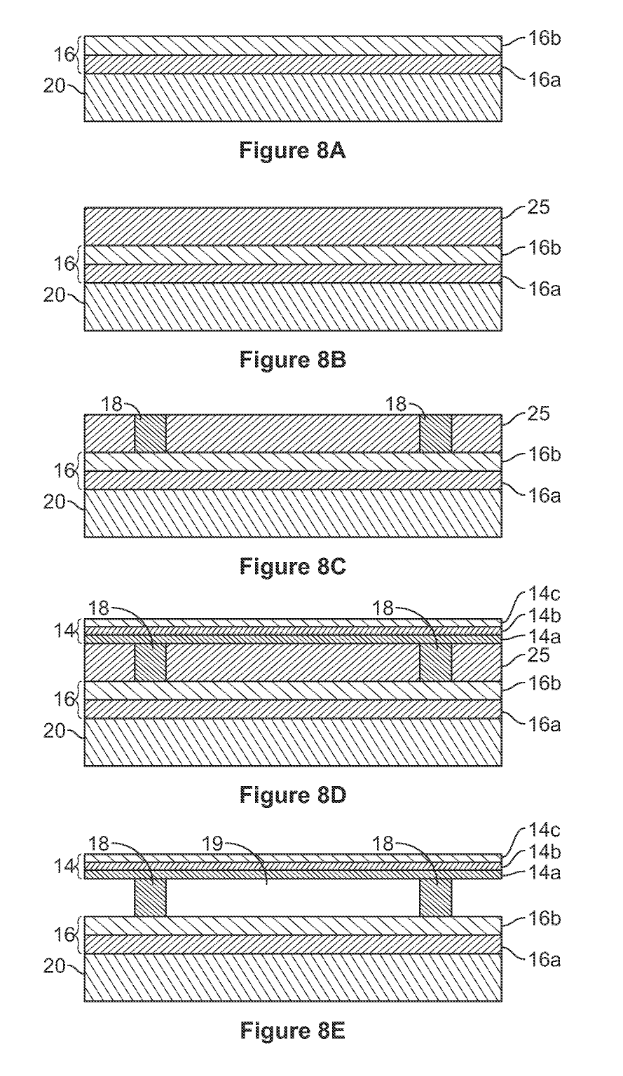

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

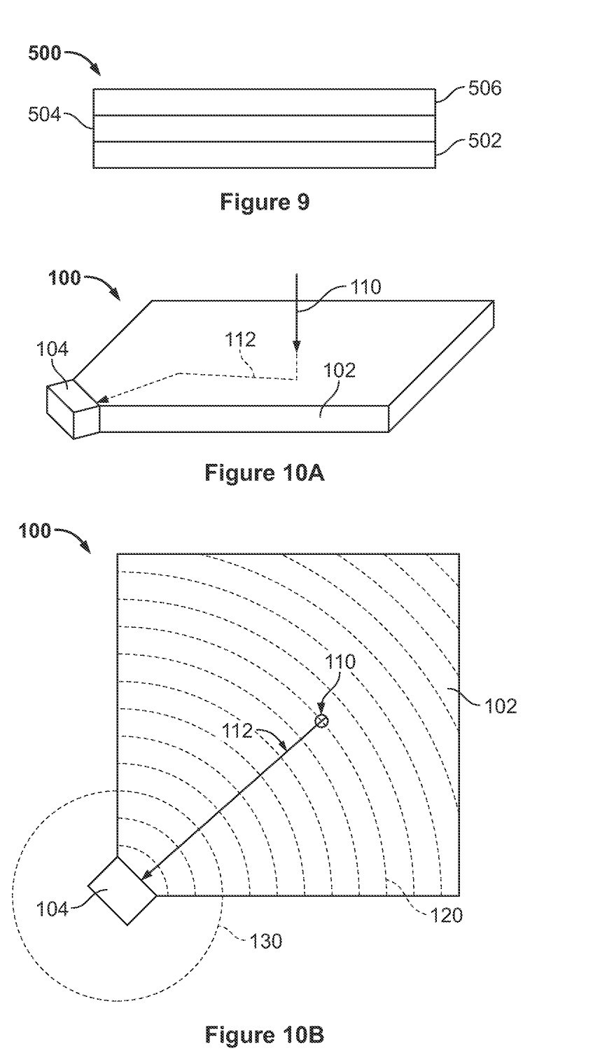

FIG. 9 shows an interface device 500 including a display device 502 and an input device 506. In some implementations, the input device 506 can include a lens layer disposed in front of the display device 502 and optically coupled to an imaging sensor so as to allow capture of an image of a user viewing the display device 502. As one can see, such a visual interface capability where images of the user looking directly at the display device 502 are captured can provide a number of useful features. For example, applications such as video-conferencing and interactive video games can be implemented where participants can interact with eye-to-eye type of interactions. Thus, in some implementations, the interface device 500 can be part of a variety of electronic devices such as portable computing and/or communication devices and configured to provide user interface functionalities.

In some implementations, the display device 502 can include one or more features or implementations of various devices, methods, and functionalities as described herein in reference to FIGS. 1-8. In other words, such devices can include various implementations of interferometric modulators, including but not limited to the examples of implementations of interferometric modulators described and/or illustrated herein.

In some implementations, the input device 506 can be combined with an interferometric modulator based display device to form the interface device 500. As described herein, however, various features of the input device 100 do not necessarily require that the display device 502 be a device based on interferometric modulators. In some implementations, the display device 502 can be one of a number of display devices, such as a transreflective display device, an electronic ink display device, a plasma display device, an electro chromium display device, an electro wetting display device, a DLP display device, an electro luminescence display device. Other display devices also can be used.

In some implementations, the input device 506 can be substantially in contact with the display device 502. In some implementations, as shown in FIG. 9, the input device 506 and the display device 502 can be separated by a region 504. Such a region 504 can include an optically transmissive medium (such as air or cladding for a light guide), an optical isolation layer or a coupling material such as an adhesive. In some implementations, one or more optical elements can be positioned in the region 504 so as to provide one or more functional features. For example, an optical element positioned in the region 504 can be configured to accommodate viewing of the display device 502. In another example, in low index implementations, a light guide can be provided in the region 504 such that light can be trapped within the light guide so as to reduce cross-talk between the display device 502 and the input device. In some implementations, the input device 506 may have lateral dimensions that are larger, about the same, or smaller that lateral dimensions of the display device 506.

FIGS. 10A and 10B show the imaging device 502 such as a camera 100 including a lens layer 102 with curvilinear features configured to turn incident light rays from an object, and a detector 104 configured to detect such turned light rays so as to allow formation of an image of the object. In some implementations, the lens layer 102 can be an example of an image capture unit. Such an image capture unit can include one or more focusing and/or lens structures, or structures that yield equivalent results. In some implementations the lens layer 102 can be a substantially flat and optically transmissive layer having a number of light turning features 120 that are configured to turn certain incident rays toward the imaging sensor 104. For example, a ray 110 is depicted as being incident on the lens layer 102 and turned into a ray 112 that propagates within and is guided in the lens layer 102 (e.g., via total internal reflection) towards the imaging sensor 104. Non-limiting examples of the turning features 120 are described herein in greater detail.

In the example configuration shown in FIGS. 10A and 10B, the imaging sensor 104 is depicted as being positioned at or near a corner of the lens layer 102. In some implementations, an imaging sensor can be positioned at or near other portions of the lens layer. For example, an imaging sensor can be positioned at or near a straight edge portion of the lens layer.

In some implementations, the imaging sensor 104 can be based on an array of detector elements (e.g., pixels). Such an array can be arranged in two dimensions so as to provide a two-dimensional imaging capability. In some implementations, the imaging sensor can be configured to receive an optical image formed thereon, detect the optical image, and generate electrical signals that can be processed to yield a representation of the optical image. Non-limiting examples of the imaging sensor 104 can include CCD and CMOS devices.

In some implementations, an edge portion of the lens layer where the imaging sensor is positioned can be configured to allow passage of light rays from the turning features to the imaging sensor. For example, if the imaging sensor is placed at a corner, that corner can be provided with a substantially flat and optically transmissive surface (such as by removing an isosceles right triangle shape from a right-angle corner) so as to accommodate passage of light rays from the lens layer to the imaging sensor 104.

In some implementations, optical coupling of the image sensor 104 and the edge portion of the lens layer 102 can be achieved by one or more known techniques. Further, one or more optical elements (not shown) can be provided between the image sensor 104 and the lens layer 102 so as to facilitate manipulation of the light rays and/or formation of images. For example, one or more lenses can be provided to facilitate the image formation.

FIG. 10B shows that in some implementations, the turning features 120 can include a plurality of curved features formed at or near one or more surfaces of a transmissive layer so as to provide functionalities associated with the lens layer 102. In the example depicted in FIG. 10B, the turning features 120 can define portions of concentric or approximately concentric circles (an example circle depicted as 130), such that an incident ray turned by a given curved feature is directed radially towards the center. For example, the incident ray 110 is shown to be directed towards the center of the example circle 130.

Although various examples of the turning features are described herein in the context of circles, other curved shapes also can be utilized. In some implementations, a curved turning feature does not necessarily need to be a smooth curve. For example, a number of straight segments can be provided such that a collection of such segments approximates a curve.

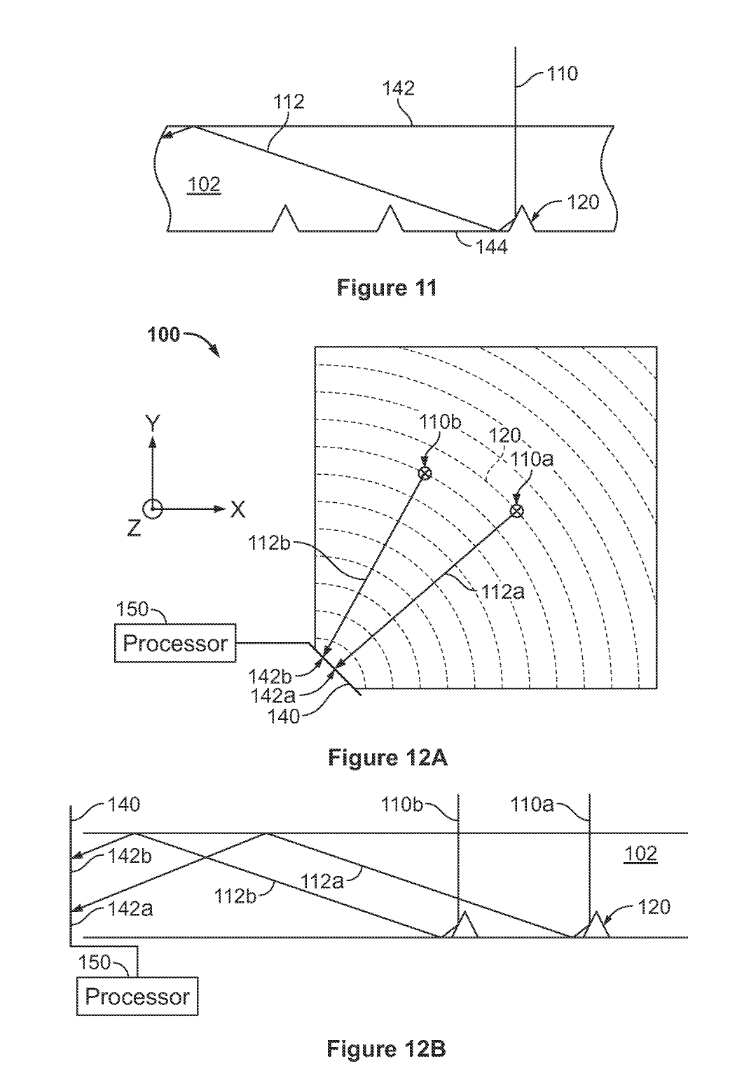

FIG. 10B depicts a plan view of an example of the turning features 120 that are curved. FIG. 11 shows an example of an incident light ray being turned by a curvilinear feature of the lens layer. More particularly, FIG. 11 depicts a side sectional view of the lens layer 102, showing an example profile and positioning of the turning features 120. In the example shown in FIG. 11, the turning features 120 are formed on the opposite side 144 (from the incidence side 142) of the lens layer 102. Each of the turning features can include a surface (e.g., an angled surface) for reflecting the incident ray 110 (e.g., via specular reflection such as from total internal reflection) that has entered the lens layer 102 from the incidence side. The turning features 120 can be dimensioned and spaced along the lens layer 102 such that the initially reflected ray propagates (depicted as ray 112) either directly or via one or more reflections (such as via total internal reflection) to the imaging sensor (not shown). Non-limiting examples of the turning feature profiles are described herein in greater detail.

In some implementations, the lens layer 102 can be based on a light guide such as a flat light guide. Such a light guide can be configured to guide light received from outside and guide it laterally towards an edge portion. The lateral direction of such guided light can be determined by a turning feature that receives the light from the outside. Operation of such a light guide can be based on, for example, total internal reflection (TIR) resulting from mismatches of the light guide's refractive index with those media on both sides of the flat light guide.

In the context of light guides, the turning features 120 can be part of a light guide (e.g., features formed on a surface of the light guide), part of a separate layer such as a film with turning features, or some combination thereof.

As described in reference to FIGS. 10 and 11, light rays incident on the lens layer 102 can be turned towards a desired region such as a corner or edge of the lens layer 102. FIGS. 12A and 12B show an example of image formation based on detection of turned light rays. For the purpose of description of FIGS. 12A and 12B, an example coordinate system is shown, where a plane defined by the lens layer 102 defines the XY plane.

In a plan view of FIG. 12A, first and second example rays 110a, 110b are depicted as being incident on the lens layer 102. The first ray 110a is incident on one of the turning features 120, and the second ray 110b on another turning feature. The first incident ray 110a is depicted as being directed to a first location 142a on an imaging sensor 140 as ray 112a, and the second incident ray 110b is depicted as being directed to a second location 142b on the imaging sensor 140 as ray 112b.

The first and second incident rays 110a, 110b shown in FIG. 12A can originate from the different locations on an object being imaged. In the example shown in FIG. 12A, when both the first and second incident rays 110a, 110b are directed at the same angle, information about the object can be obtained from the spatial location on the lens layer 102 (e.g., front surface of lens layer 102) where the rays 110a, 110b are incident. In the example shown in FIG. 12A, azimuthal locations (relative to a common center of concentric turning features, for example) of the first and second incident rays 110a, 110b can be determined based on detection of the turned rays 112a, 112b at their respective lateral components of the sensor locations 142a, 142b. In the particular example shown in FIG. 12A, the first and second incident rays 100a, 110b, also have different radial locations or distances (relative to a common center of concentric turning features, for example) that can also be distinguished based on where light is detected on the sensor 140 as discussed below in connection with FIG. 12B. In some implementations, therefore, a processor 150 in communication with the imaging sensor 140 can be configured to process signals associated with the sensed locations so as to determine the azimuthal (and/or radial) locations of the incident rays. The angle of incidence of the light may also affect the location where the light rays are directed onto the sensor 140, but it has been assumed for simplicity in this example, that the incident rays 110a, 110b are substantially the same, such is the cases for collimated rays (e.g., the object is distant). Accordingly, in various implementations, for example, unique mapping information that maps incident points on the lens layer 102 to points on the sensor can facilitate such a determination. Such mapping information can be based on a map having first order x-y mapping estimates for a given incidence angle value or a range of values. A number of sets of such mapping estimates can be determined and provided to accommodate different incidence angles or ranges of angles.

In the particular example shown in FIG. 12A, two rays incident on the same azimuth but on different radial locations may not be distinguished based solely on the lateral components of the detected sensor locations. FIG. 12B depicts a situation in a sectional side view, where first and second rays 110a, 110b are incident on different turning features 120 that are at different radial locations. The azimuthal locations of the rays 110a, 110b may or may not be the same in FIG. 12B. The first incident ray 110a is depicted as propagating in the lens layer 102 as ray 112a and being detected at a first location 142a on the imaging sensor 140. Similarly, the second incident ray 110b is depicted as propagating in the lens layer 102 as ray 112b and being detected at a second location 142b on the imaging sensor 140. In the example shown in FIG. 12B, radial locations (relative to a common center of concentric turning features, for example) of the first and second incident rays 110a, 110b can thus be determined based on detection of the turned rays 112a, 112b at their respective Z components of the sensor locations 142a, 142b. In some implementations, the processor 150 can be configured to process signals associated with the sensed locations so as to determine the radial locations of the incident rays and/or the location of the object.

In various implementations, both angle of incidence as well as spatial location on the lens layer 102 (e.g., front surface of lens layer 102) can be mapped to a corresponding “output” location on one of the surfaces of the light guide 102 (such as the edge where the detector 140 is located). In some other implementations, however, the output location can be at other locations such as top, bottom, or other edges of the light guide/lens layer 102. The subset of those rays that are guided within the light guide/lens layer 102 via total internal reflection (e.g., are within the total internal reflection or critical angles) strike the image sensor 140 and are employed to reconstruct the object image. Other rays may be redirected out of the light guide/lens layer 102 and may thus not reach the detector 140. Accordingly, in various implementations, the location of objects or features on one or more objects in front of or forward the lens layer 102 can be can be mapped to a unique corresponding “output” location on one of the surfaces of the light guide (such as the edge where the detector 140 is located) and on the detector 140 itself.

Based on the foregoing examples depicted in FIGS. 12A and 12B and associated discussion, rays associated with an object in front of the lens layer 102 (e.g., at positive Z location) can be detected by the imaging sensor 140. Signals associated with such detections can be processed by the processor 150 so as to yield an image associated with the object. In some implementations, such processing of detected signals and image construction can be achieved using one or more known image processing techniques.

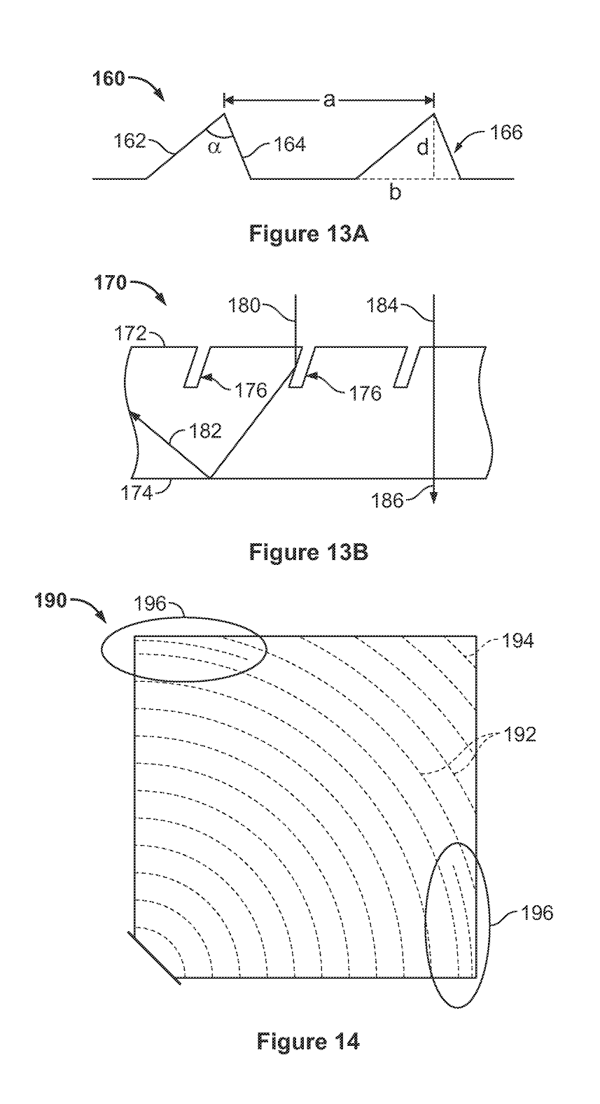

FIGS. 13A and 13B show examples of light turning features that can be formed on either or both sides of a lens layer. FIG. 13A shows an example configuration 160 where a number of turning features 166 can be formed on a lens layer on its side opposite from the incidence side. Various examples of how incident light rays can be turned are described herein (such as FIGS. 11 and 12B).

FIG. 13B shows another example configuration 170 where a number of turning features 176 can be formed on a lens layer on its incidence side. In the example configuration 170, the turning features 176 are depicted as being formed on or near a surface 172 on the incident side of the lens layer. Accordingly, an example ray 180 incident on one of the turning features 176 is depicted as being turned by the turning feature (e.g., via specular reflection such as from total internal reflection) and propagating within the lens layer as ray 182 (e.g., via total internal reflection from one or both of the surfaces 174, 172). Another example ray 184 is depicted as being incident on the lens layer such that it misses the turning features 176 and is not turned.

The turning features as described herein can be dimensioned to provide one or more desired functionalities. For example, FIG. 13A shows that in some implementations, height (d), lateral dimension (such as a base dimension b), and angles of the feature's faces 162, 164 (via angle α) can be selected to control one or more light turning properties of the features 166. Further, spacing (a) of the turning features 166 also can be selected to control, for example, resolution capability of the lens layer. Examples of design variations to address one or more of the foregoing performance characteristics are described herein in greater detail.

In some implementations, the lens layer can be formed from an optically transmissive material that is substantially transparent to radiation at one or more wavelengths. For example, a lens layer may be transparent to wavelengths in the visible and near infra-red region. In another example, a lens layer may be transparent to wavelengths in the ultra-violet or infra-red regions.

In some implementations, a lens layer having one or more features as described herein can be formed from rigid or semi-rigid material such as glass or acrylic so as to provide structural stability and/or protection. Alternatively a lens layer can be formed of flexible material such as a flexible polymer.

In some implementations, various turning features as described herein may be prismatic, diffractive, holographic (e.g., holographic lens), or any other mechanism for turning light from a direction incident upon the upper or lower surface of a lens layer to a direction laterally toward an edge portion (e.g., a corner) of the lens layer shaped and angled to facilitate image formation. Thus, an image formed in such a manner can be detected by a sensor such as a two-dimensional sensor (e.g., CCD or CMOS array sensors). In the example shown in FIGS. 13A and 13B, the turning features 166 are prismatic type features that operate based on the principle of reciprocity. In other words, light can travel in a forward and backward direction along a path between the surface of the lens layer and a selected edge. Similarly, diffractive or holographic features that form a diffractive optical element (e.g., lens) or hologram (e.g., holographic lens) that collect and turn the light and form an image on the imaging sensor can be used.

In some implementations, such turning features can be elongated grooves formed on one of the surfaces (e.g., opposite from the incident side) of the lens layer. In some implementations, the grooves may be filled with an optically transmissive material. In some implementations, such grooves can be formed on a surface of an optically transmissive substrate by molding, embossing, etching or other alternate techniques. Alternatively the grooves can be disposed on a film which may be laminated on the surface of the optically transmissive substrate. In some implementations, the prismatic turning features can include a variety of shapes, including but not limited to V-shaped grooves and slits.

FIGS. 14-18 show non-limiting examples of configurations that can be implemented to address various operating concerns. In some implementations, turning features as described herein can be distributed on a given lens layer to provide one or more desired performance characteristics. Such a distribution of turning features can include, for example, a series of concentric circular shaped curves spaced substantially uniformly, or a series of curves spaced in some varying manner.

FIG. 14 shows that in some implementations, light turning feature parameters such as density and type can be adjusted to accommodate various design needs. For example, a lens layer 190 can have a distribution of turning features 192. In some implementations, the lens layer 190 can further include one or more regions 196 where additional turning features are provided. In the example shown, the two corners adjacent from the imaging sensor are provided with additional turning features to, for example, improve image forming performance at the corners.

FIG. 14 also shows that in some implementations, the lens layer 190 can include one or more turning features (depicted as 194) that are of a different type than the others (e.g., the main turning features 192). Such a difference can include, for example, location of the turning features (e.g., incident side or opposite side), profile shape of the turning features, and/or dimensions of the turning features. Similar to the foregoing corner performance enhancing example, different types of turning features can be provided at different regions of the lens layer 190 to achieve one or more desired performance characteristics.

In some implementations, two or more lens layers can be combined to provide one or more functionalities. For example, two lens layers, each having certain distribution of turning features (e.g., uniformly distributed features) can be disposed next to each other and offset laterally so as to yield effectively an increased density of turning features.

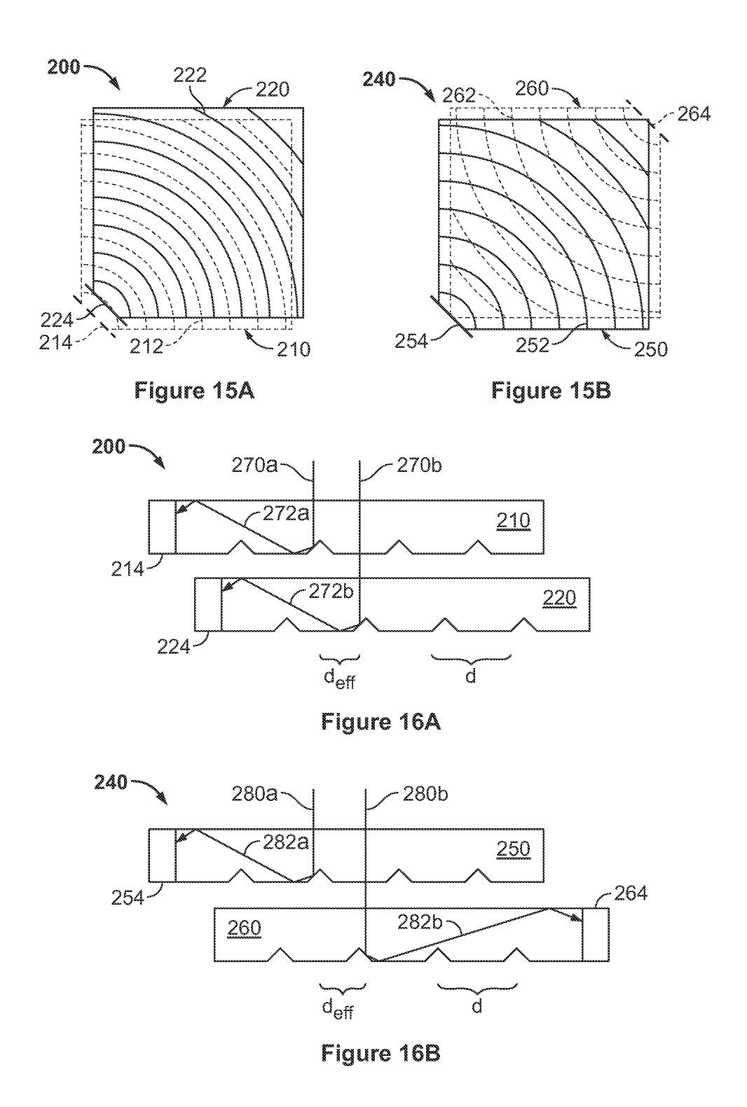

FIGS. 15A and 15B show an imaging device including more than one lens layers so as to provide features such as improved spatial resolution. FIGS. 16A and 16B show side sectional views, respectively, of the example implementations of FIGS. 15A and 15B.

For example, FIG. 15A shows an example configuration 200 where two lens layers 210, 220 can be positioned so that the first lens layer's (210) turning features 212 are shifted relative to the second lens layer's (220) turning features 222. FIG. 16A shows a side sectional view of the example configuration 200. In FIG. 16A, first and second incident rays 270a, 270b are depicted as being turned by two adjacent turning features so as to yield their respective turned rays 272a, 272b. In some other example configurations, more than two lens layers whose turning features are shifted can be provided so as to yield a desired resolution capability.

In the example shown in FIGS. 15A and 16A, the first and second lens layers 210, 220 are oriented so that their corresponding imaging sensors 214, 224 are similarly oriented. Accordingly, whereas each lens layer has a turning feature spacing of d (assuming in this example substantially uniform spacing), the combination of the two lens layers 210, 220 has an effective turning feature spacing of d_{eff} that is less than d. If one specific example where the turning features of one lens layer is shifted by half-spacing, the effective spacing d_{eff} can be approximately d/2.

In the example shown in FIGS. 15A and 16A, the shifted turning features can provide increased resolution capability (by reducing the effective turning feature spacing) substantially throughout the areas of the two lens layers. In some other implementations, the two lens layers also can be oriented differently relative to each other. For example, FIG. 15B shows an example configuration 240 where two lens layers 250, 260 can be positioned so that their corresponding imaging sensors 254, 264 are positioned at opposing corners. FIG. 16B shows a side sectional view of the example configuration 240. In FIG. 16B, first and second incident rays 280a, 280b are depicted as being turned by two adjacent turning features so as to yield their respective turned rays 282a, 282b that propagate in opposite directions toward their respective imaging sensors 254, 264.

In the example shown in FIGS. 15B and 16B, each lens layer has a turning feature spacing of d (assuming in this example substantially uniform spacing). Unlike the example of FIGS. 15A and 16A, however, the combination of the two lens layers 250, 260 yields an effective turning feature spacing of d_{eff} that can vary at different locations. For example, along a diagonal line between the two imaging sensors 254, 264, d_{eff} can be about d/2 if the two lens layers are shifted by half-spacing along the diagonal. As shown, other areas of the lens layer combination can include effective spacing values that are less than or greater than the d/2 value.

In some implementations, two or more lens layers can be positioned so that their respective turning features and imaging sensor are arranged differently than the examples of FIGS. 15 and 16. In the examples described in reference to FIGS. 15 and 16, two or more lens layers can be combined to provide one or more capabilities beyond that provided by a single lens layer/single imaging sensor combination. In some implementations, at least some of such capabilities also can be provided by a configuration where a single lens layer has more than one set of turning features and more than one corresponding imaging sensors.

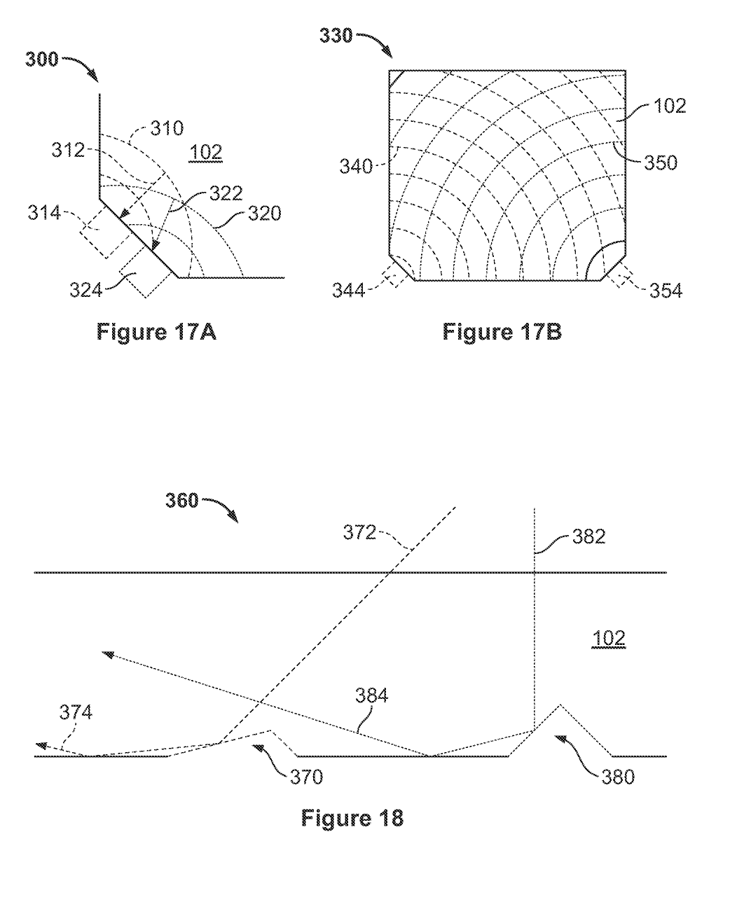

FIGS. 17A and 17B shows that in some implementations, more than one set of light turning features and detectors can be provided for a given lens layer. Images can be formed by such different sets of turning features and captured by their corresponding imaging sensors. In FIG. 17A, an example configuration 300 includes a lens layer 102 having two sets of turning features 310, 320. The two sets of turning features 310, 320 are shown to be configured to turn incident rays towards their respective imaging sensors 314, 324 positioned at or near the same corner of the lens layer 102. A ray depicted as arrow 312 is representative of rays turned by the first set of turning features 310 and directed toward the first imaging sensor 314. Similarly, a ray depicted as arrow 322 is representative of rays turned by the second set of turning features 320 and directed toward the second imaging sensor 324.

In FIG. 17B, an example configuration 330 includes a lens layer 102 having two sets of turning features 340, 350. The two sets of turning features 340, 350 are shown to be configured to turn incident rays towards their respective imaging sensors 344, 354 positioned at or near different corners of the lens layer 102. For the first set of turning features 340, its corresponding first imaging sensor 344 is positioned at the first corner. For the second set of turning features 350, its corresponding second imaging sensor 354 is positioned at the second corner that is different than the first corner. In the example shown in FIG. 17B, the first and second corners are selected to be adjacent corners. In another implementation, the first and second corners can be selected to be opposing corners.

In some implementations, the two or more sets of turning features described by way of examples of FIGS. 17A and 17B can be configured differently so as to provide different turning functionalities. For example, two or more sets of turning features can be utilized to obtain corresponding two or more different perspective images (e.g., two or more angular perspectives obtained by configuring the turning angles slightly differently); and such images can be used to reconstruct a three-dimensional view. In some implementations, the two example sets of turning features and their corresponding imaging sensors of FIGS. 17A and 17B can be configured to image different components (e.g., different wavelength contents such as infrared and visible regions) of generally the same object. In various implementations, for example, one of the image sensors 344 could be sensitive to one wavelength region (such as infrared) and another image sensor 354 could be sensitive to a different wavelength region (such as visible) and the different sets of turning features 340, 350 could direct light from the object to the respective sensors 344, 354. For example the first set of turning features 340 could image the object onto the first image sensor 344 and the second set of turning features 350 could image the object onto the second image sensor 354. Accordingly, the lens layer 102 would be optically transmissive to both wavelength regions (such as infrared and visible) and the respective sets of turning features 340, 350 would be configured to operate on these different wavelength regions (e.g., IR and visible, respectively). The lens layer 102 and sensors 314, 324, 344, 354 can be configured as shown in FIGS. 17A and 17B or can be configured differently, for example, the number, and/or location of the turning features and/or sensors may be different.

In another example, two or more sets of turning features and their corresponding imaging sensors (e.g., those of FIGS. 17A and 17B) can be configured to receive, turn, and detect rays from different incident angles. FIG. 18 shows that in some implementations, light turning features can be configured to receive and turn rays incident at different angles. An example configuration 360 can include a lens layer 102 having two sets of different turning features configured to turn incident rays at different angles. A first turning feature 370 is depicted as receiving a first incident ray 372 from a first direction (relative to the incident surface of the lens layer 102) and turn it into a first turned ray 374. A second turning feature 380 is depicted as receiving a second incident ray 382 from a second direction that is different than the first direction and turn it into a second turned ray 374. In some other implementations, more than two sets of such turning features can be provided.

A lens layer can be configured to redirect (e.g., focus) light rays incident from one or more directions relative to the incident surface of the lens layer thereby forming images of different objects that provide light. An example application of such a feature can include a lens layer where images corresponding to a number of objects at different directions can be combined so as to yield a wide-angle or panoramic-view image. In another example, one or more objects at one or more locations relative to a lens layer can be imaged separately by one or more sets of turning features and their corresponding imaging sensors.

There are a number of applications where one or more features as described herein can be implemented. For example, any user-interfaces having visual or video capability can benefit from use of a lens layer as described herein. Video conferencing is an example where such a video user interface is utilized. In many video conferencing systems, a video camera is positioned at or near the periphery of a display device such as a monitor. Typically, a first user of such a system finds it more natural to look at the monitor and not the camera. Accordingly, a second user viewing the first user will see the first user not looking at the camera and thereby not providing an eye-contact atmosphere that the video conference is trying to facilitate.

Such a situation can be more pronounced in certain video conferencing settings. For example, videoconferencing applications where a user is positioned relatively close to a monitor such as a laptop or desktop computer monitor can result in a relatively high angle between the user's line of vision (to, for example, a center portion of the monitor) and a camera (e.g., a webcam positioned at or near an edge of the monitor). Accordingly, the user as viewed through the camera will appear to be looking elsewhere more prominently.

In some implementations, a lens layer having one or more features as described herein can be positioned between a user and a display device such as a monitor. In some implementation, such a lens layer can be configured as a cover plate for the monitor so as to provide cover functionality as well as ensuring that images of a user obtained via the lens layer will likely show the user looking at the monitor, and thus the lens.

In some implementations, a lens layer or an assembly of lens layers can be configured to form images of an object positioned generally at a selected location. For example, turning features of such a lens layer can be configured to form images of an object that is generally directly in front of the lens layer (e.g., at or near normal to the lens layer). In another example, turning features can be configured to account for a likely viewing angle (e.g., away from the normal line) between the user and the lens layer.

In some implementations, a lens layer or an assembly of lens layers can be configured to form images of a number of objects positioned at a number of different angles relative to the lens layer. For example, and as described in reference to FIGS. 17 and 18, images of two or more objects at different angles can be obtained by two or more sets of turning features and their corresponding imaging sensors. Assuming that such two or more objects represent two or more users looking at a common monitor, images of the users will show the users looking at the camera, even if the users are positioned at different locations. In some implementations, such images of the users captured by lens layer can be processed and presented other participant(s) as separate images, or as a composite image showing all of the captured user images.

In some implementations, a lens layer and its corresponding imaging sensor can be utilized in manners other than those associated with video or visual interface situations. For example, a lens layer can be configured to be utilized as a transparent overlay over another object such as a display item (e.g., a poster, artwork, signs, etc.). Used in such a manner, the lens layer can be utilized to form images of one or more objects viewing the display item and/or the display item itself.

In the context of imaging objects viewing the display item, images obtained accordingly can be utilized to, for example, monitor who is viewing the display item. In the context of imaging the display item itself, a lens layer can be configured and dimensioned so as to allow, for example, imaging of a sheet in contact with or close to the lens layer. The lens layer may for example be used to image photos, documents, bar codes, or other surfaces. Accordingly, in various implementations, the lens layer may be used in grocery store and/or inventory scanning devices as well as in copiers and/or document scanning equipment, which can be used to form an electronic copy of a document. The lens layer may be also used in optical instrumentation such as microscopes, endoscopes, and other instruments including other medical or biological instruments, that image or take optical measurements (e.g., spectroscopic measurements) of a sample and/or sample surface.

Whether a lens layer is utilized in combination with an active display (e.g., as a monitor cover) or a substantially static display (e.g., an overlay for a poster), the lens layer may capture extraneous images that are undesirable. In some implementations, processing of signals from an imaging sensor can be processed so as to remove such extraneous images. For example, if information concerning the source of an extraneous image is known, an image processing can include accounting of such information so as to allow removal of such an extraneous image from a detected image obtained from an imaging sensor. In some implementations, such information can be obtained if the extraneous image corresponds to a known static object such as a poster or display driver/frame buffer associated with an active display.

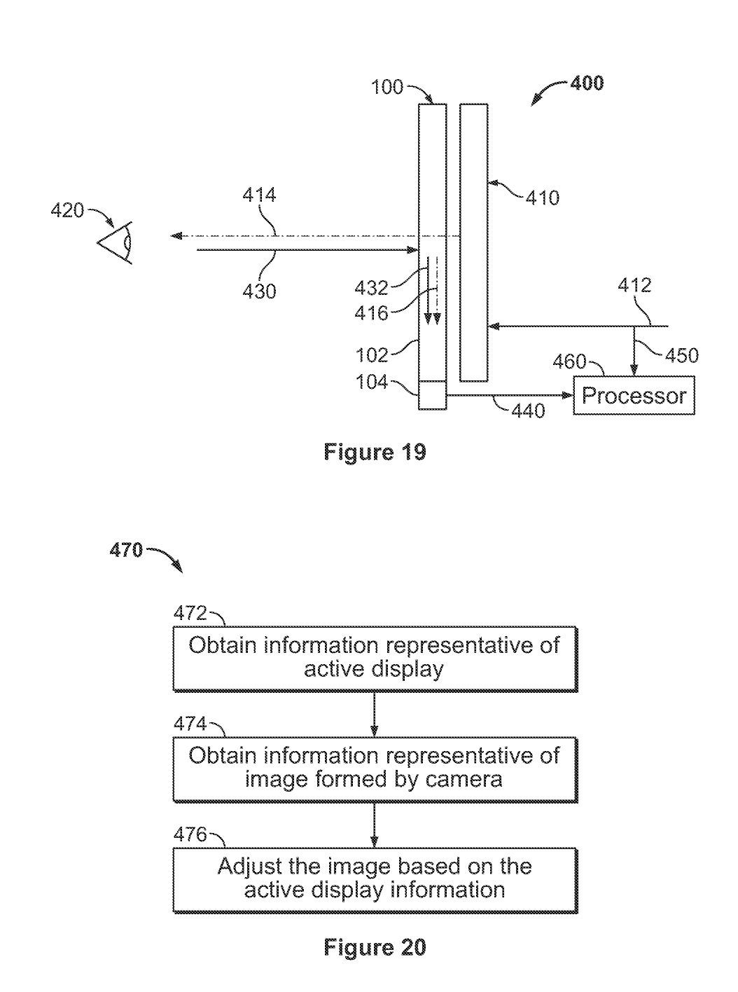

In the context of active displays, FIG. 19 shows an example configuration of the interface device of FIG. 9, where an image of a user viewing an active display device can be formed by a lens layer and a detector, and where such an image can be adjusted to account for artifacts resulting from known frames being provided to the active display device. In some implementations, an interface system 400 can include a camera 100 positioned between a viewer 420 and an active display device 410. As described herein, the camera 100 can include a lens layer 102 and an imaging sensor 104 configured to provide one or more features as described herein. The active display device 410 can include but is not limited to an interferometric modulator based display device, an LCD device, and a plasma display device, in additional to a variety of other display devices.

As shown in FIG. 19, the active display device 410 can be driven by a signal 412 so as to yield a visual output 414 viewable by the viewer 420. Such driving of the display device 410 and generation of the visual output 414 can be achieved in a number of known ways. In the example shown in FIG. 19, the visual output 414 travels through the lens layer 102 that is intended to capture (depicted as arrow 432) and redirect, (e.g., focus) rays 430 from the viewer 420 thereby imaging the viewer. Thus, in certain situations, a portion of the visual output 414 may be captured by the lens layer 102 and turned (arrow 416) towards the imaging sensor 104. Such a captured artifact of the visual output 414 can be undesirably included with the viewer's image in an output 440 of the imaging sensor 104.

In some implementations, at least some information associated with the input signal 412 can be provided (arrow 450) to a processor 460. The processor 460 also can be configured to process the output signal 440 of the imaging sensor 104 and remove the artifact of the visual output 414 based on the known information (from the input signal 412) about the visual output 414. Such processing of signals and images to correct for known artifacts can be achieved in a number of known ways.

FIG. 20 shows a process 470 that can be implemented to perform the example image adjustment depicted in FIG. 19. In block 472, information representative of an active display can be obtained. In block 474, information representative of an image formed by a camera can be obtained. As described herein, such information can include images of both a desired object (such as viewer) and an artifact of the active display. In block 476, the image can be adjusted based on the active display information.

In some implementations, a processor (e.g., 460 in FIG. 19) can be configured to perform and/or facilitate one or more of processes as described herein. In some implementations, a computer-readable medium can be provided so as to facilitate various functionalities provided by the processor.

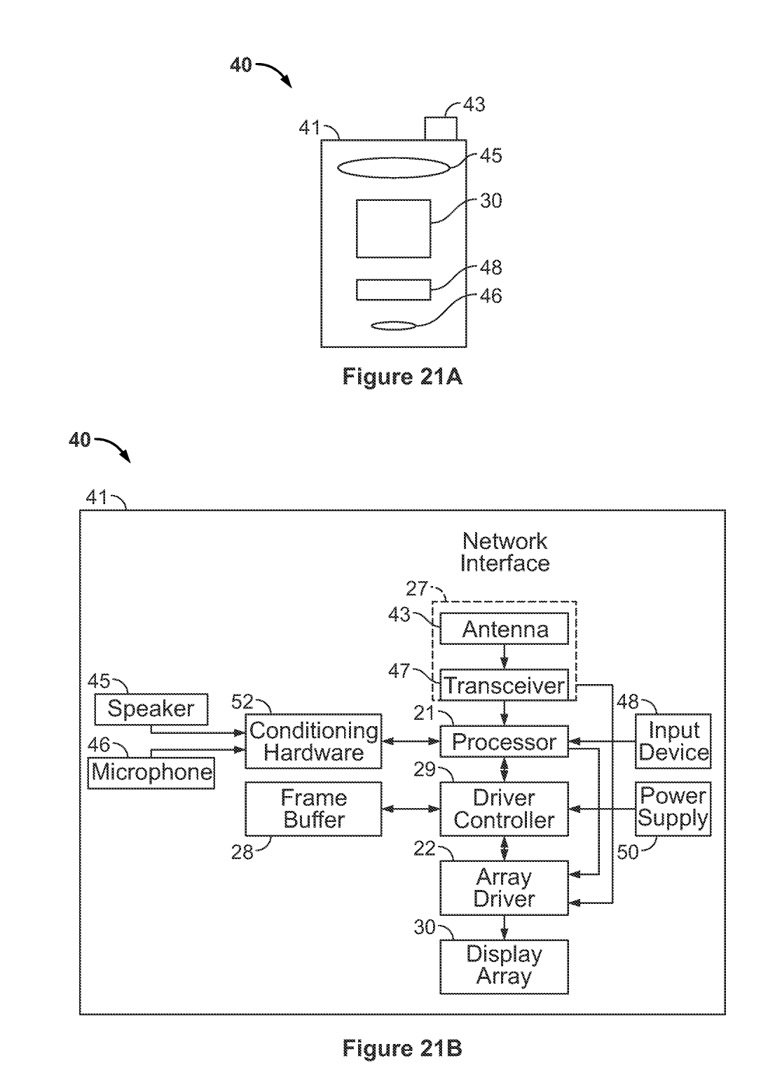

FIGS. 21A and 21B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 21B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An imaging device, comprising:
an optically transparent lens layer forming a light guide and having a plurality of curved features, at least some of the curved features configured to turn light rays incident thereon toward an edge portion of the lens layer; and
an imaging sensor positioned relative to the edge portion of the lens layer and configured to receive at least some of the turned light rays so as to allow formation of an image based on the incident rays.

2. The device of claim 1, wherein the optically transparent layer has a substantially uniform thickness.

3. The device of claim 1, wherein the plurality of curved features includes a plurality of circular arc shaped features.

4. The device of claim 3, wherein the circular arc shaped features are substantially concentric about a center that is located at or near the imaging sensor.

5. The device of claim 1, wherein the plurality of curved features are spaced uniformly.

6. The device of claim 1, wherein the plurality of curved features are spaced in a varying manner.

7. The device of claim 1, wherein the lens layer comprises a rectangular shaped layer.

8. The device of claim 7, wherein the edge portion of the lens layer includes a corner of the rectangular shaped layer.

9. The device of claim 7, wherein the rectangular shaped layer includes a rectangular shaped sheet having a thickness that is less than either of the sheet's length and width.

10. The device of claim 9, wherein the corner of the rectangular shaped layer defines a substantially flat surface that is substantially perpendicular to a plane defined by the lens layer and configured to allow passage of the at least some of the turned light rays from the lens layer to the imaging sensor.

11. The device of claim 1, wherein the curved features are formed on one of two surfaces of the lens layer.

12. The device of claim 11, wherein the curved features include prismatic features.

13. The device of claim 12, wherein the prismatic features include facets or grooves.

14. The device of claim 1, wherein the curved features include a first set of curved features distributed on the lens layer, and a second set of curved features distributed on one or more areas of the lens layer so as to provide a different light turning functionality than that of the first set of curved features.

15. A user interface apparatus, comprising:
an active display device configured to receive an input signal and generate a visual display viewable from a viewing side of the active display device; and
a camera including a lens layer and an imaging sensor disposed at or near an edge of the lens layer, the lens layer having features configured to turn incident light rays to the imaging sensor, the imaging sensor configured to receive the turned light rays and generate signals that allow formation of an image corresponding to the incident light rays,
wherein the lens layer is disposed relative to the active display device such that the camera is capable of forming an image of an object positioned on the viewing side of the active display device.

16. The apparatus of claim 15, further comprising:
a processor that is configured to communicate with the active display device, the processor being configured to process display data for generating the visual display; and
a memory device that is configured to communicate with the processor.

17. The apparatus of claim 16, wherein the active display device includes a plurality of interferometric modulators.

18. The apparatus of claim 16, further comprising:
a driver circuit configured to send at least one signal to the active display device; and
a controller configured to send at least a portion of the display data to the driver circuit.

19. The apparatus of claim 16, further comprising a display source module configured to send the display data to the processor.

20. The apparatus of claim 19, wherein the display source module includes at least one of a receiver, transceiver, and transmitter.

21. The apparatus of claim 16, wherein the processor is further configured to process the signals from the imaging sensor so as to form the image.

22. The apparatus of claim 21, wherein the processor is further configured to account for a portion of the visual display detected by the imaging sensor via the lens layer and adjust the image based on the display data.

23. The apparatus of claim 15, further comprising a second camera.

24. The apparatus of claim 23, wherein the two cameras are positioned such that the features of one camera are laterally offset from the features of the other camera.

25. The apparatus of claim 15, wherein the camera further comprises a second imaging sensor coupled to the lens layer and a second set of features on the lens layer configured to turn and focus incident light rays from a second location to a second imaging sensor.

26. The apparatus of claim 25, wherein the first and second locations are different locations at the viewing side of the active display device.

27. The apparatus of claim 25, wherein the first and second imaging sensors are positioned adjacent to each other at the edge of the lens layer.

28. The apparatus of claim 25, wherein the first and second imaging sensors are positioned at opposing locations along the edge of the lens layer.

29. The apparatus of claim 15, wherein the lens layer is dimensioned substantially similar to the lateral dimensions of the active display device so as allow the lens layer to function as a cover plate for the active display device.

30. The apparatus of claim 15, wherein the lens layer includes a substantially flat lens layer.

31. The apparatus of claim 15, wherein the object includes a user looking at the active display device.

32. A method for operating a user interface, comprising:
providing an input signal to an active display device so as to generate a visual display;
obtaining an image signal representative of an object positioned on a viewing side of the active display device, the image of the object formed by an optical element positioned between the object and the active display device, the optical element optically transparent so as to allow the visual display to be viewed through the optical element such that the image signal includes at least some display image representative of the visual display; and
adjusting the image signal based on the input signal to remove at least a portion of the image signal so as to enhance the image of the object in the image signal.

33. The method of claim 32, wherein the object includes a user looking at the active display device.

34. The method of claim 32, wherein the adjusting of the image signal includes filtering the at least some display image from the image signal.

35. The method of claim 32, wherein the adjusting of the image signal includes removing fixed-pattern noise from the image signal.

36. The method of claim 32, wherein the display image corresponds to an image in a buffer at the time when the image signal is obtained.

37. An apparatus comprising:
means for forming an image of an object with light guided therein, the image formed at or near an edge portion of the image forming means; and
means for sensing the image so as to generate an image signal.

38. The apparatus of claim 37, wherein image forming means includes a lens layer and said image sensing means includes an image sensor.

39. The apparatus of claim 38, wherein the lens layer includes a plurality of curved features so as to turn incident light rays from the object to the edge portion of the lens layer.

40. The apparatus of claim 38, further comprising means for displaying a visual image viewable through the lens layer.

41. The apparatus of claim 40, further comprising means for adjusting the image signal to remove an additional image formed at or near an edge portion of the light guide, the additional image corresponding to at least some of the visual displaying means.

42. The apparatus of claim 41, wherein the visual displaying means includes an active visual display.
